(19) United States
(12) Patent Application Publication
(10) Pub. No.: US 2022/0156033 A1
(43) Pub. Date: May 19, 2022

(54) METHOD OF CHANGING OPERATION BASED ON MUSIC TRANSITION

(71) Applicant: AMERICAN FUTURE TECHNOLOGY, City of Industry, CA (US)

(72) Inventor: You-Chi LIU, City of Industry, CA (US)

(21) Appl. No.: 17/116,325

(22) Filed: Dec. 9, 2020

Related U.S. Application Data
(63) Continuation-in-part of application No. 17/098,853, filed on Nov. 16, 2020.

(51) Int. Cl. G06F 3/16; G10L 25/18; G10L 25/51

(52) U.S. Cl. CPC G06F 3/165; G10H 2210/071; G10L 25/51; G10L 25/18

(57) ABSTRACT

A method of changing operation based on music transition is disclosed. In the method, an electronic device performs Fourier series transform on a sound signal of music to obtain a rhythm diagram of the sound signal, and then performs an operation to extract a rhythm segment point of a rhythm diagram, a waveform and a spectrogram of the sound signal, when each of intensity of the rhythm diagram, intensity of the waveform and magnitude of the spectrogram has a drop of a preset percentage at the same time for a preset time, a time point of the drop is used as the rhythm segment point, the sound signal of the music is faded out, and the electronic device transmits an operation signal to an operation device at the rhythm segment point. After receiving the operation signal, the operation device performs the corresponding action based on the operation signal.

This application is a Continuation-In-Part of application Ser. No. 17/098,853, filed on Nov. 16, 2020, for which priority is claimed under 35 U.S.C. § 120, the entire contents of which are hereby incorporated by reference.

### BACKGROUND OF THE INVENTION

### 1. Field of the Invention

The present invention relates to a method of changing operation based on music transition. More particularly, in the method of the present invention, an electronic device performs Fourier series transform on a sound signal produced by at least one musical instrument, to obtain a rhythm diagram of the sound signal, and when each of the intensity of the rhythm diagram, intensity of waveform of the sound signal, and magnitude of the spectrogram of the sound signal has a drop of a preset percentage at the same time, the operation device performs an action, so that the operation device can change action at the music transition.

### 2. Description of the Related Art

With the rapid development of technology, simple auditory enjoyment is more and more difficult to satisfy people's sensory requirement, so many music devices are designed to provide audiences more visual experience and add more atmospheres to the audiences in the process of listening to music. For example, most of the conventional music-and-lighting interactive devices can control the lighting effects through the system preset by the lighting manufacturers, and the program for adjusting light color and brightness according to the style and rhythm of the played music is pre-installed in the music-and-light interaction device, and the program can be executed to produce light animation during the performance of the music.

However, the above-mentioned pre-setting method usually fails to provide the best combinational effects of music and lighting, and may cause the poor sensory experience and reduce the live music atmosphere. Moreover, creation of the lighting interaction effects for many pieces of music has high time and effort cost, so the lighting manufacturer does not create the lighting interaction effect for every piece of music. Moreover, the lighting manufacturer usually adjusts the light color and brightness based on the change points of magnitude and frequency of sound, but these two methods may disorder the lighting interaction effect to make the audience uncomfortable. Furthermore, people feel the variation of music mainly based on the rhythm in the music, and the rhythm is combination of the timing, sequence, intensity and weakness of music, and the music fails to proceed in an orderly manner without rhythm.

However, conventionally, the sound and light effects of the background are unchanged while music is played or performed, and if the background sound and light effects remain unchanged even the repertoire of the music (such as symphony) is changed during the transition, the audience may feel that the visual effect is not good and have bad and boring musical sensory experience at the scene, and it affects the audience's willingness to watch again.

Therefore, how to automatically extract the rhythm of the music and produce lighting effects in accordance with the rhythm is a key issue in this industry.

### SUMMARY OF THE INVENTION

Therefore, in order to solve conventional problems, the inventors develop a method of changing operation based on music transition, according to collected data, multiple tests and modifications and years of experience in the industry.

An objective of the present invention is that an electronic device performs Fourier series transform on a sound signal, which is produced by at least one musical instrument, of music, to obtain a rhythm diagram of the sound signal, and the rhythm diagram presents intensity variation of the sound signal at at least one frequency over time; the electronic device then performs an operation to extract a rhythm segment point of a rhythm diagram, an waveform and a spectrogram of the sound signal, and when each of intensity of the rhythm diagram, intensity of the waveform, and magnitude of the spectrogram has a drop of a preset percentage at the same time for a preset time, a time point of the drop is used as the rhythm segment point, the sound signal of the music is faded out and the electronic device transmits an operation signal to an operation device at the rhythm segment point; the operation device performs a corresponding action according to the operation signal after receiving the operation signal. As a result, the operation device can perform action based on the rhythm produced by the at least one musical instrument, and further change action at the music transition, so as to achieve the purpose of improving overall appreciation of music performance.

### BRIEF DESCRIPTION OF THE DRAWINGS

The structure, operating principle and effects of the present invention will be described in detail by way of various embodiments which are illustrated in the accompanying drawings.

FIG. 1 is a rhythm diagram of the present invention.

FIG. 2 is a flowchart of a method of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

As used herein, the term “or” includes any and all combinations of one or more of the associated listed items. It will be acknowledged that when an element or layer is referred to as being “on,” “connected to” or “coupled to” another element or layer, it can be directly on, connected or coupled to the other element or layer, or intervening elements or layers may be present, In contrast, when an element is referred to as being “directly on,” “directly connected. to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

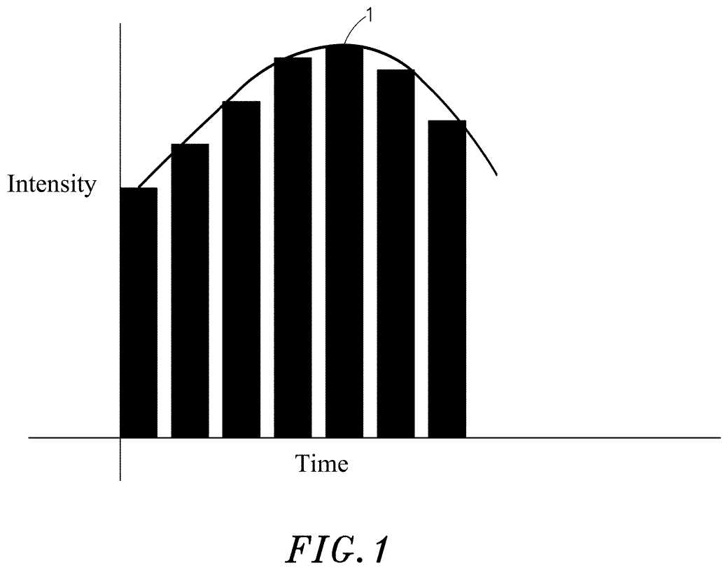

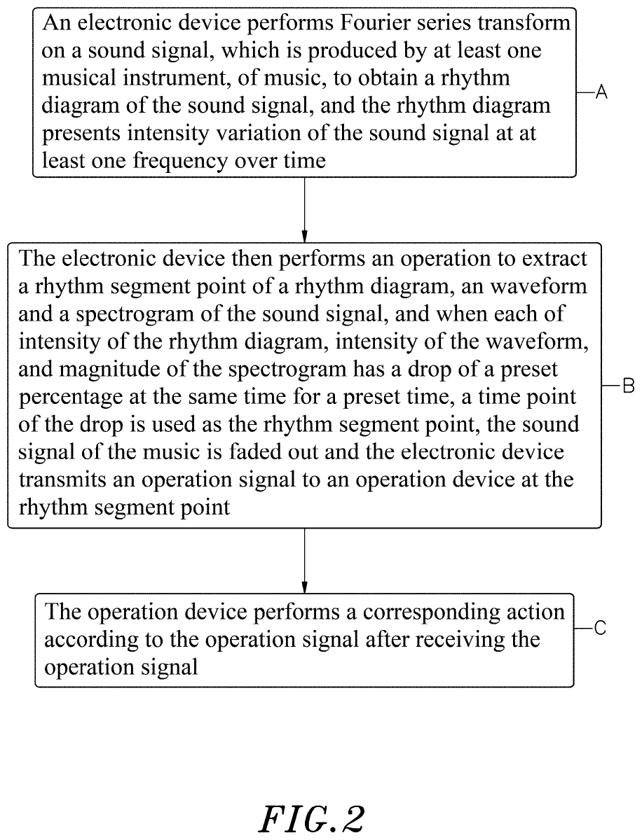

Please refer to FIGS. 1 and 2, which are a rhythm diagram and a flowchart of a method of the present invention. As shown in FIG. 2, the method of the present invention includes following steps.

In a step (A), an electronic device performs Fourier series transform on a sound signal, which is produced by at least one musical instrument, of the music, to obtain a rhythm diagram of the sound signal. In an embodiment, the at least one musical instrument can be, for example but not limited, a guitar, a drum, a bass, a piano, a cymbal or other musical instrument. The rhythm diagram presents intensity variation of the sound signal at at least one frequency over time.

In a step (B), the electronic device performs an operation to extract a rhythm segment point 1 of the rhythm diagram, the waveform and the spectrogram of the sound signal, and when each of intensity of the rhythm diagram, intensity of the waveform and magnitude of the spectrogram has a drop of a preset percentage at the same time for a preset time, a time point of the drop is used as the rhythm segment point 1, and at this time the sound signal of the music is faded out, and the electronic device transmits an operation signal to an operation device at the rhythm segment point 1.

In a step (C), after receiving the operation signal, the operation device performs the corresponding action according to the operation signal, so as to complete the using process of the present invention.

Preferably, the above electronic device can be a desktop computer, a notebook computer, a tablet computer, a smartphone, a personal digital assistant, or other electronic device with computing functions.

Preferably, the electronic device used in the step (B) can transmit the operation signal to the operation device through a transmission line; however, in actual applications, the operation signal can also be transmitted to the operation device by a wireless transmission manner, such as WI-FI, Bluetooth or infrared transmission.

In an embodiment, the operation device used in the step (B) can be a light emitting device (such as an LED), a water spray device, a flamethrower, a dry ice spray device, a pyrotechnic device, or other operation device capable of performing the action in cooperation with the music performance. For example, the light emitting device can be used to perform light variation, simulate water dance variation, simulate torch variation, or perform arbitrary scene lighting effects variation with the rhythm, magnitude and level of sound. In an embodiment, the water spray device, the flamethrower, the dry ice spray device, the pyrotechnic device or other operation device can be used to spray fire, spray water, spray dry ice, set off fireworks or perform other actions, respectively. It should be noted that there are many types of operation devices capable of receiving the operation signals to perform actions with the rhythm of music, magnitude and level of sound, so various equivalent structural changes, alternations or modifications based on the descriptions and figures of present invention are all consequently viewed as being embraced by the spirit and the scope of the present invention set forth in the claims.

In an embodiment, the preset percentage described in the step (B) is lower than 5%, and the preset time is less than 3 seconds.

In practical use of the method of the present invention, the electronic device performs Fourier series transform on the sound signal produced by the at least one musical instrument, to obtain the rhythm diagram of the sound signal, and the electronic device then performs the operation to extract the rhythm segment point 1 of the rhythm diagram, the waveform and the spectrogram; for example, when each of the intensity of the rhythm diagram, the intensity of the waveform and magnitude of the spectrogram has the drop of the preset percentage at the same time for the preset time, the time point of the drop is used as the rhythm segment point 1, and at this time the sound signal of the music is faded out, and the electronic device transmits the operation signal to the operation device at the rhythm segment point 1. After receiving the operation signal, the operation device performs the corresponding action according to the operation signal. As a result, the operation device can perform action with the rhythm, magnitude and level of sound produced by the at least one musical instrument, and the operation device can change action at the music transition, for example, a new video animation can be played when the chapter is changed during performance of symphony, so as to improve the overall appreciation of music performance.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method of changing operation based on music transition, comprising following steps:
(A): performing, by an electronic device, Fourier series transform on a sound signal, which is produced by at least one musical instrument, of music, to obtain a rhythm diagram of the sound signal, wherein the rhythm diagram presents intensity variation of the sound signal at at least one frequency over time;
(B): performing, by the electronic device, an operation to extract a rhythm segment point of the rhythm diagram, an waveform and a spectrogram of the sound signal, wherein when each of intensity of the rhythm diagram, intensity of the waveform, and magnitude of the spectrogram has a drop of a preset percentage at the same time for a preset time, a time point of the drop is used as the rhythm segment point, the sound signal of the music is faded out and the electronic device transmits an operation signal to an operation device at the rhythm segment point; and
(C): performing, by the operation device, a corresponding action according to the operation signal after receiving the operation signal.

2. The method according to claim 1, wherein the electronic device is a desktop computer, a notebook computer, a tablet computer, a smartphone or a personal digital assistant.

3. The method according to claim 1, wherein the operation device is a light emitting device, a water spray device, a flamethrower, a dry ice spray device or a pyrotechnic device.

4. The method according to claim 1, wherein the preset percentage defined in the step (B) is lower than 5%, and the preset time defined in the step (B) is less than the 3 seconds.
